(19) United States
(12) Patent Application Publication
(10) Pub. No.: US 2018/0293687 A1
(43) Pub. Date: Oct. 11, 2018

(54) RIDESHARING MANAGEMENT FOR AUTONOMOUS VEHICLES

(71) Applicant: International Business Machines Corporation, Armonk, NY (US)

(72) Inventors: Christopher J. Hardee, Raleigh, NC (US); Steven R. Joroff, River Vale, NJ (US); Pamela A. Nesbitt, Ridgefield, CT (US); Scott E. Schneider, Rolesville, NC (US)

(21) Appl. No.: 15/483,097

(22) Filed: Apr. 10, 2017

(51) Int. Cl. G06Q 50/30; G06Q 10/06; G06Q 10/00; G07C 5/00; G08G 1/123

(52) U.S. Cl. CPC G06Q 50/30; G06Q 10/06315; G05D 1/0088; G07C 5/008; G08G 1/123; G06Q 10/20

(57) ABSTRACT

Embodiments include method, systems and computer program products for ridesharing management for autonomous vehicles. In some embodiments, a rideshare request is received for an autonomous vehicle. Data associated with a user associated with the autonomous vehicle can be obtained from a user device. Preference data associated with the owner can be obtained. Vehicle data associated with the autonomous vehicle can be obtained. It can be determined that the autonomous vehicle is available for ridesharing using the data associated with the user, the owner preference data, the vehicle data, and the rideshare request. Ridesharing data can be generated using the data associated with the user, the owner preference data, the vehicle data, and the rideshare request. The ridesharing data can be transmitted to the autonomous vehicle to facilitate ridesharing based at least in part on the ridesharing data.

### BACKGROUND

The present invention relates in general to data processing, and more specifically, to methods, systems and computer program products for ridesharing management for autonomous vehicles.

Ridesharing is a real-time service that coordinates shared rides on very short notice, often using GPS navigation devices, mobile devices (e.g., smartphones, tablets, etc.), and social networking technologies. Ridesharing is also known as instant ridesharing, dynamic ridesharing, ad-hoc ridesharing, on-demand ridesharing, dynamic carpooling, or real-time ridesharing. Ridesharing services are used to better utilize empty seats in passenger cars, which lower fuel usage and transport costs. Ridesharing services can provide driver payments and match riders and drivers using an optimization algorithm.

### SUMMARY

In accordance with an embodiment, a method for ridesharing management for autonomous vehicles is provided. The method can include receiving a rideshare request for an autonomous vehicle. Data associated with a user associated with the autonomous vehicle can be obtained from a user device. Preference data associated with an owner of the autonomous vehicle can be obtained. Vehicle data associated with the autonomous vehicle can be obtained. It can be determined that the autonomous vehicle is available for ridesharing using any of the following: the data associated with the user, the owner preference data, the vehicle data, and the rideshare request. Ridesharing data can be generated using any of the following: the data associated with the user, the owner preference data, the vehicle data, and the rideshare request. The ridesharing data can be transmitted to the autonomous vehicle to facilitate ridesharing based at least in part on the ridesharing data.

In another embodiment, a computer program product can comprise a non-transitory storage medium readable by a processing circuit that can store instructions for execution by the processing circuit for performing a method that can include receiving a rideshare request for an autonomous vehicle. Data associated with a user associated with the autonomous vehicle can be obtained from a user device. Preference data associated with an owner of the autonomous vehicle can be obtained. Vehicle data associated with the autonomous vehicle can be obtained. It can be determined that the autonomous vehicle is available for ridesharing using any of the following: the data associated with the user, the preference data, the vehicle data, and the rideshare request. Ridesharing data can be generated using any of the following: the data associated with the user, the preference data, the vehicle data, and the rideshare request. The ridesharing data can be transmitted to the autonomous vehicle to facilitate ridesharing based at least in part on the ridesharing data.

In another embodiment, a system can include a processor in communication with one or more types of memory. The processor can be configured to receive a rideshare request for an autonomous vehicle. Data associated with a user associated with the autonomous vehicle can be obtained from a user device. Preference data associated with an owner of the autonomous vehicle can be obtained. Vehicle data associated with the autonomous vehicle can be obtained. It can be determined that the autonomous vehicle is available for ridesharing using any of the following: the data associated with the user, the preference data, the vehicle data, and the rideshare request. Ridesharing data can be generated using any of the following: the data associated with the user, the preference data, the vehicle data, and the rideshare request. The ridesharing data can be transmitted to the autonomous vehicle to facilitate ridesharing based at least in part on the ridesharing data.

### BRIEF DESCRIPTION OF THE DRAWINGS

The forgoing and other features, and advantages of the disclosure are apparent from the following detailed description taken in conjunction with the accompanying drawings in which:

FIG. 1 is a block diagram illustrating one example of a processing system for practice of the teachings herein;

FIG. 2 is a block diagram illustrating a computing system in accordance with an exemplary embodiment;

FIG. 3 is a flow diagram of a method for ridesharing management for autonomous vehicles in accordance with an exemplary embodiment;

FIG. 4 depicts a cloud computing environment in accordance with an exemplary embodiment; and

FIG. 5 depicts abstraction model layers in accordance with an exemplary embodiment.

### DETAILED DESCRIPTION

In accordance with exemplary embodiments of the disclosure, methods, systems and computer program products for ridesharing management for autonomous vehicles are provided. The systems and methods described herein are directed to the utilization of individually owned autonomous vehicles to intelligently provide ridesharing services by determining when and how the autonomous vehicle is available to provide ridesharing services.

In an example embodiment, a rideshare management server can receive a request from a third-party ridesharing service for an autonomous vehicle. In response to receiving the request, the rideshare management server can identify an owner associated with the autonomous vehicle and obtain information associated with the owner, such as calendar information, location information, and the like. The term “owner” can refer to actual ownership, individually assigned ownership or group ownership. The rideshare management server can also obtain preference information associated with the owner (e.g., owner-specified preferences for use of their car in a ride-sharing service) as well as vehicle data associated with the autonomous vehicle. The rideshare management server can analyze the information from the rideshare request, data associated with the owner (e.g., calendar information), owner preference information, and vehicle data to determine that the autonomous vehicle is available for the requested rideshare. The rideshare management server can determine availability for a route identified in the rideshare request using different factors. These factors include, but are not limited to, the time an owner needs to leave their location for an event on their calendar, whether the autonomous vehicle needs fuel before the owner of the autonomous vehicle needs to leave based at least in part on the trip planned for the owner (e.g., determining additional time is needed to route the vehicle to get fuel on the way to the owner or after the owner), where the ride sharing route would end, a projected completion time for the rideshare, how long it would take the autonomous vehicle to return to the owner, if more than one of the users of the vehicle is co-located and will be traveling together, whether the user has indicated multiple people will be traveling together but need to be picked up at different locations, or the like.

Other factors can include a calculated risk derived from the autonomous vehicle being removed from availability of the owner. For instance, if the autonomous vehicle is part of a group, at least one car of the group can be scheduled to be available for an owner, regardless of not having a scheduled event for the owner, based at least in part on the risk that one of the owners will need access to it. For example, in a group of ten family and friends, the group can set a rule to ensure that at least two autonomous vehicles are available at all times beyond the scheduled events during predetermined hours during the week, while more may need to be available during the weekend. Such a rule can be explicitly specified by the group or can be learned from the use of the group over time.

In some embodiments, the autonomous vehicle may be associated with a group of autonomous vehicles available for ridesharing. The group can be a self-selected or self-organized group, where owners choose to join a group. The group can be automatically organized by the rideshare management server based at least in part on geographic location, type of vehicle, or other factor. If a group of vehicles is made available for ridesharing services, the rideshare management server can make a determination which of the vehicles is available for rideshare based at least in part on different factors including, but not limited to, if maintenance of the vehicle will be required during use or will come within a threshold of needing it, attempting to average use across the vehicles of the group over time, based at least in part on the most efficient vehicle for that route based at least in part on energy use and proximate location of the ride needed, users of the group that need rides next based at least in part on their schedules, capabilities of the vehicle (e.g., cargo space, child seating availability, four-wheel drive, etc.), current location of the vehicles (e.g., leaving vehicles centrally located based at least in part on the owners locations), and the like.

In some embodiments, the rideshare management server can manage the monetary transactions for a group. For example, the group can set a base amount to allocated per vehicle involved and allocate additional funds obtained through ridesharing based at least in part on actual use of vehicles, directs costs associated with the vehicles (e.g., fuel, maintenance, etc.), depreciation of the vehicle based at least in part on mileage used for rideshare for each car, or the like.

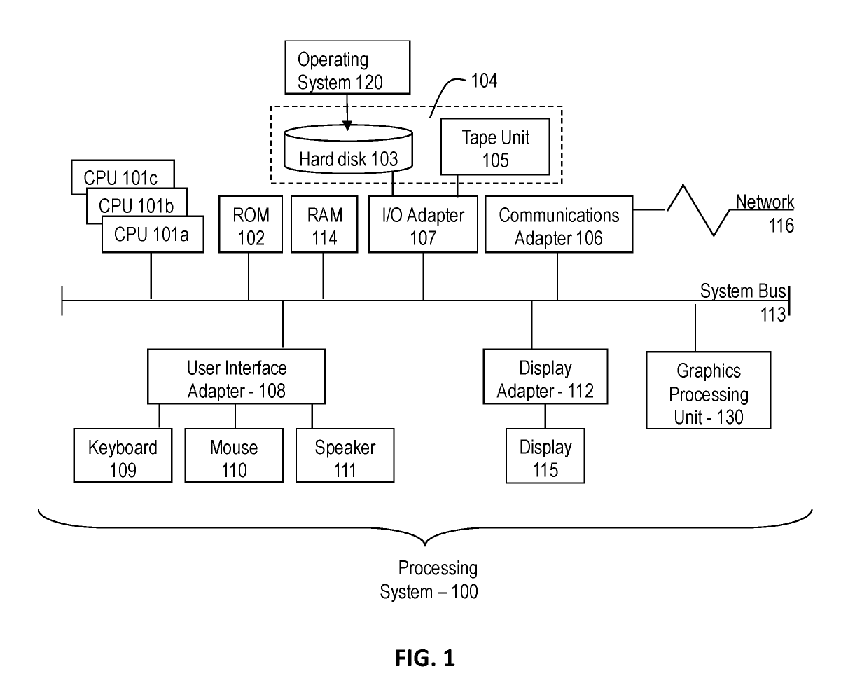

FIG. 1 further depicts an input/output (I/O) adapter 107 and a communications adapter 106 coupled to the system bus 113. I/O adapter 107 can be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 can be stored in mass storage 104. A communications adapter 106 interconnects bus 113 with an outside network 116 enabling data processing system 100 to communicate with other such systems. A screen (e.g., a display monitor) 115 is connected to system bus 113 by display adapter 112, which can include a graphics adapter to improve the performance of graphics intensive applications and a video controller. In one embodiment, adapters 107, 106, and 112 can be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnect to bus 113 via user interface adapter 108, which can include, for example, a Super I/O chip integrating multiple device adapters into a single integrated circuit.

In exemplary embodiments, the processing system 100 includes a graphics-processing unit 130. Graphics processing unit 130 is a specialized electronic circuit designed to manipulate and alter memory to accelerate the creation of images in a frame buffer intended for output to a display. In general, graphics-processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

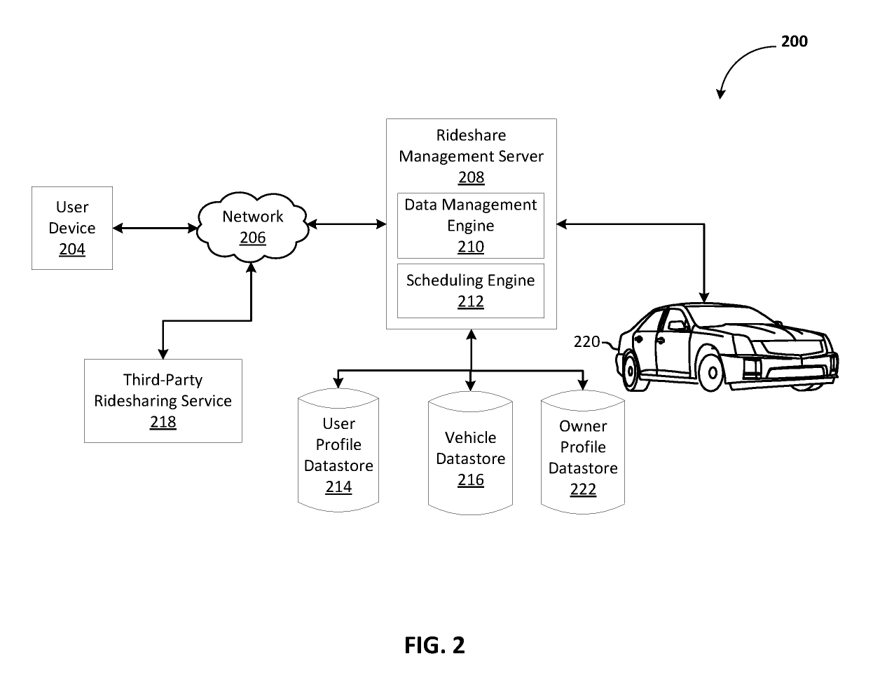

Referring now to FIG. 2, a computing system 200 in accordance with an embodiment is illustrated. As illustrated, the computing system 200 can include, but is not limited to, one or more user devices 204, a rideshare management server 208, a third-party ridesharing service 218, a user profile datastore 214, a vehicle datastore 216, an owner profile datastore 222 and/or one or more autonomous vehicles 220, connected via one or more networks 206. Although depicted as a client-server architecture, in some embodiments, the methods and systems described herein can be implemented using a cloud service architecture, where the user device 204, rideshare management server 208, third-party ridesharing server 218, user profile datastore 214, owner profile datastore 222, and/or vehicle datastore 216 and/or static analysis server 216 communicate with functionality provided in a cloud computing environment.

The user device 204 can be any type of computing device, such as a computer, laptop, tablet, smartphone, wearable computing device, server, etc. The user device 204 can be capable of communicating with other devices over one or more networks 206. The user device 204 can be able to execute applications and tools used to request rideshares, scheduling calendar events, using social networking sites, interacting with a third-party ridesharing service 218 or an autonomous vehicle 220, and the like.

The network(s) 206 can include, but are not limited to, any one or a combination of different types of suitable communications networks such as, for example, cable networks, public networks (e.g., the Internet), private networks, wireless networks, cellular networks, or any other suitable private and/or public networks. Further, the network(s) 206 can have any suitable communication range associated therewith and can include, for example, global networks (e.g., the Internet), metropolitan area networks (MANs), wide area networks (WANs), local area networks (LANs), or personal area networks (PANs). In addition, the network(s) 206 can include any type of medium over which network traffic can be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

In some embodiments, the rideshare management server 208 can be any type of computing device with network access, such as a computer, laptop, server, tablet, smartphone, wearable computing devices, or the like. The rideshare management server 208 can be a component of a cloud-computing architecture. In some embodiments, the rideshare management server 208 can be located partially or fully on the autonomous vehicle 220. The rideshare management server 208 can include a data management engine 210 and/or a scheduling engine 212.

The data management engine 210 can include computer-readable instructions that in response to execution by the processor(s) 101, cause operations to be performed including receiving requests for a rideshare for an identified autonomous vehicle 220. The data management engine 210 can parse the request to identify the autonomous vehicle 220 and associated owners. The data management engine 210 can obtain information associated with owners from the owner profile datastore 222, for example, calendar information, autonomous vehicle maintenance preferences, owner-specified preferences for use of an associated autonomous vehicle in a ride-sharing service, etc. The data management engine 210 can obtain additional information from a user device 204 of the user (e.g., scheduled events in a calendar application, etc.), user profile data of the user from a user profile datastore 214 (e.g., preferences set by the user regarding rideshare use, travel history, payment information, etc.) The data management engine 210 can additionally obtain vehicle data associated with the autonomous vehicle 220 from a vehicle datastore 216. A third-party rideshare service 218 can be a service that facilitates ridesharing among people and drivers using social network and mobile devices. The user profile datastore 214 can be any type of storage device that stores and manages user profile data associated with users of the system 200. User profile data may include biographical information, vehicle preferences, route preferences, payment information, rideshare history, special vehicle requests (e.g., car seats required, large cargo seat requested, DVD availability, or the like). Vehicle profile data (e.g., vehicle data) can be stored in a vehicle datastore 216. The vehicle datastore 216 can be any type of storage device that stores and manages vehicle profile data associated with autonomous vehicles. Examples of vehicle data can include type of vehicle, vehicle identifier, vehicle description, vehicle maintenance records, rules associated with the use of an autonomous vehicle 220 (which may also be applied to a group of autonomous vehicles) for ridesharing, and the like.

The data management engine 210 can transmit the obtained information to a scheduling engine 212. In some embodiments, the data management engine 210 can determine that the autonomous vehicle 220 is part of a group of autonomous vehicles for ridesharing purposes. The data management engine 210 can obtain data associated with all the owners associated with the group as well as rules that are associated with the group for ridesharing.

The scheduling engine 212 can include computer-readable instructions that in response to execution by the processor(s) 101, cause operations to be performed including receiving data from the data management engine 218. The scheduling engine 212 can use the information received from the data management engine 210 to determine that the autonomous vehicle 220 is available to fulfill the request. In some embodiments, the scheduling engine 212 can determine potential routes for the autonomous vehicle 220 using the information obtained from the data management engine 210. The scheduling engine 212 can generate rideshare information. Examples of rideshare information may include, but are not limited to information about the requested rideshare (e.g., location of the requestor, destination, etc.), potential routes for the requested rideshare, identification of any conflicts (e.g., scheduling), potential fare, and the like. The scheduling engine 212 can determine, using the rideshare information, that the potential routes in combination with the needs of the owner associated with the autonomous vehicle 220 permit the autonomous vehicle 220 to be available for the requested rideshare. If the scheduling engine 212 determines that the requested rideshare does not pose a scheduling conflict or otherwise negatively impact the availability of the autonomous vehicle 220 for its associated owner, the scheduling engine 212 can transmit a notification to the third-party ridesharing service 218 accepting the request and then transmitting the generated rideshare information to the autonomous vehicle 220.

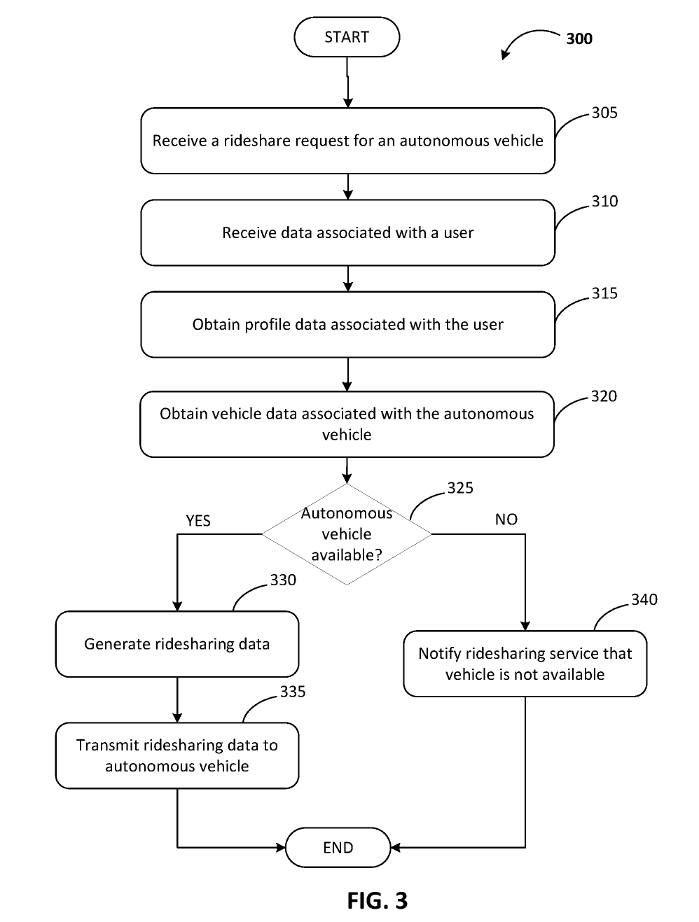

Now referring to FIG. 3, a flow diagram of a method 300 for ridesharing management for autonomous vehicles in accordance with an exemplary embodiment is depicted. At block 305, a rideshare request for an autonomous vehicle 220 can be received from a requestor/user. In some embodiments, a rideshare request from a third-party ridesharing service 218 can be received by the rideshare management server 208. The data management engine 210 of the rideshare management server 208 can receive the rideshare request and parse the request to obtain details associated with the requested rideshare. For example, the rideshare request can include an identification of the requestor, a requested autonomous vehicle 220, a time and location for pickup, a destination, special instructions (e.g., no highways, additional time, additional equipment, etc.), approximate or estimated fare, details associated with the requestor of the rideshare, and the like.

At block 310, data associated with a user can be received. In some embodiments, the data management engine 210 can obtain data associated with a user associated with the identified autonomous vehicle 220. For example, the data management engine 210 can obtain data from a user device 204 or associated computing device associated with the user to obtain scheduling information for the time period of the requested rideshare. For example, the data management engine 210 can obtain calendar information from the user device 204 or other computing device associated with the user. Examples of the types of information that the data management engine 210 can obtain include, but are not limited to, location of a scheduled event, starting time of the event, duration of the event, identified known attendees of the event, and the like. In some embodiments, the data management engine 210 can identify the user associated with the autonomous vehicle 220 by obtaining vehicle data from the vehicle datastore 216. The vehicle data can include one or more associated users with the autonomous vehicle 220 and/or the group of autonomous vehicles that includes the autonomous vehicle 220.

At block 315, profile data associated with the user can be obtained. The data management engine 210 can obtain owner preference information associated with the owner associated with the autonomous vehicle 220 from owner profile datastore 222. Owner preference information can include preferences set by the owner regarding use of the owned autonomous vehicle 220 for ridesharing, travel history of the owner, autonomous vehicle maintenance preferences (e.g., having a full tank of gas prior to a trip), route preferences (e.g., avoid local roads), etc. The owner profile datastore 222 can also include calendar information for the owner.

At block 320, vehicle data associated with the autonomous vehicle can be obtained. The data management engine 210 can obtain vehicle data associated with the autonomous vehicle 220. Examples of vehicle data include, but are not limited to, type of vehicle, vehicle identifier, vehicle description, vehicle maintenance records, rules associated with the use of an autonomous vehicle 220 (which may also be applied to a group of autonomous vehicles) for ridesharing, and the like.

At block 325, a determination can be made that the autonomous vehicle 220 is available for the requested rideshare. The data management engine 210 can transmit the data obtained from different sources, such as the user device 204, user profile datastore 214, vehicle datastore 216, owner profile datastore 222, and/or the third-party ridesharing service 218 to the scheduling engine 212. The scheduling engine 212 can analyze the obtained data and apply one or more optimization algorithms to determine that the requested autonomous vehicle 220 is available for the requested rideshare. In some embodiments, if the ridesharing puts an autonomous vehicle within a certain threshold distance of needing scheduled maintenance, the availability of the autonomous vehicle for the requested rideshare can be limited.

The scheduling engine 212 can analyze the information from the rideshare request, data associated with the user (e.g., calendar information), owner preference information (e.g., calendar information or preferences), and vehicle data to determine that the autonomous vehicle 220 is available for the requested rideshare. The scheduling engine 212 can determine availability for a route identified in the rideshare request using different factors. These factors include, but are not limited to, the time a user or owner needs to leave their location for an event on their calendar, that the autonomous vehicle needs fuel before the owner of the autonomous vehicle needs to leave based at least in part on the trip planned for the owner (e.g., determining additional time is needed to route the vehicle to get fuel on the way to the owner or after the owner), where the ride sharing route would end, a projected completion time for the rideshare, how long it would take the autonomous vehicle to return to the owner, if more than one of the users of the vehicle is co-located and will be traveling together, that the user has indicated multiple people will be traveling together but need to be picked up at different locations, or the like.

Other factors can include a calculated risk derived from the autonomous vehicle 220 being removed from availability of the owner. For instance, if the autonomous vehicle 220 is part of a group, at least one car of the group can be scheduled to be available for an owner, regardless of not having a scheduled event for the owner, based at least in part on the risk that one of the owners will need access to the autonomous vehicle. Rules associated with a group of autonomous vehicles 220 can be explicitly specified by the group or can be learned from the use of the group over time.

If, at block 325, the autonomous vehicle 220 is not available, then the method can proceed to block 340, where the scheduling engine can notify the third-party ridesharing service 218 that the autonomous vehicle 220 is not available. The requestor can then be notified by the third-party ridesharing service 218 that the autonomous vehicle 220 is not available.

If at block 325, the autonomous vehicle 220 is available, then the method can proceed to block 330, where the scheduling engine 212 can generate ridesharing data for the requested rideshare. Examples of ridesharing data include potential routes (e.g., taking into account user preferences, rideshare requestor/user preferences, vehicle maintenance status, traffic, and other data), estimated fare for each potential route, estimated arrival time, and the like. The scheduling engine 212 can, at block 335, transmit the ridesharing data to the autonomous vehicle 220 for routing to the pick-up destination identified by the rideshare request from the third-party ridesharing service 218. The transmission can occur using intermediary systems and/or servers, for example, rideshare management server 208, third-party ridesharing service 218 or another computing systems associated with computing system 200. The scheduling engine 212 can transmit a notification to the third-party ridesharing service 218 that the autonomous vehicle 218 is available and acceptance of the rideshare request, along with the generated rideshare data. The requestor can then be notified by the third-party ridesharing service 218 that the autonomous vehicle 220 is available.

In some embodiments, owners associated with autonomous vehicles can determine to form a group for their autonomous vehicles and may create rules to be applied to the group, ensuring that there will be enough autonomous vehicles 220 available to members of the group while permitting some of the autonomous vehicles 220 in the group to participate in ridesharing. Groups of autonomous vehicles 220 can be used by corporate carpools that determine the expected need for vehicles in the pool and then make the additional vehicles available for ridesharing.

It is understood in advance that although this disclosure includes a detailed description on cloud computing, implementation of the teachings recited herein are not limited to a cloud-computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud-computing environment is service oriented with a focus on statelessness, low coupling, modularity, and semantic interoperability. At the heart of cloud computing is an infrastructure comprising a network of interconnected nodes.

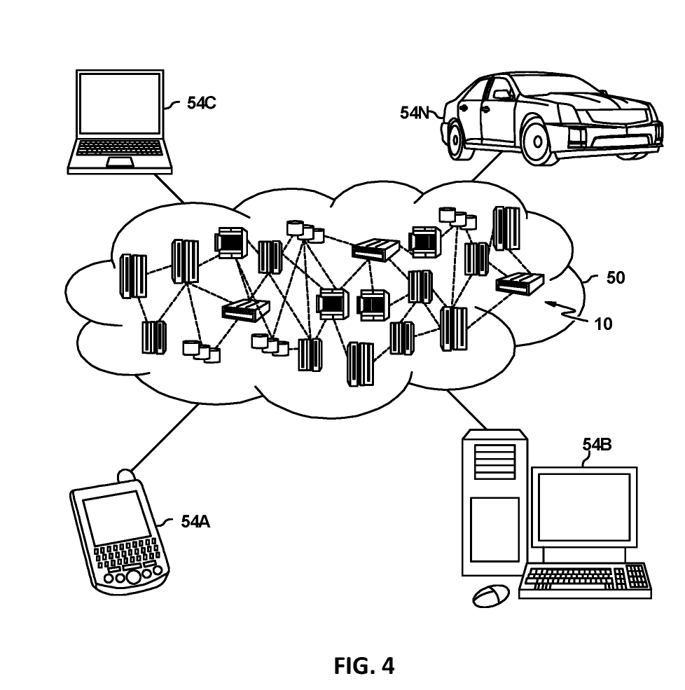

Referring now to FIG. 4, illustrative cloud computing environment 50 is depicted. As shown, cloud-computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N can communicate. Nodes 10 can communicate with one another. They can be grouped (not shown) physically or virtually, in one or more networks, such as Private, Community, Public, or Hybrid clouds as described hereinabove, or a combination thereof. This allows cloud-computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

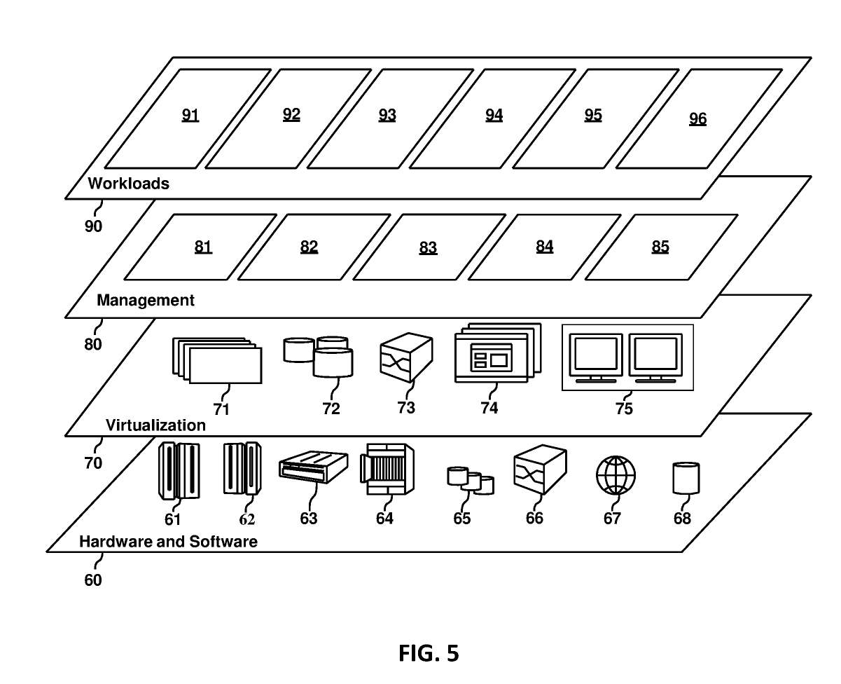

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75.

In one example, management layer 80 can provide the functions described below. Resource provisioning 81 provides dynamic procurement of computing resources and other resources that are utilized to perform tasks within the cloud-computing environment. Metering and Pricing 82 provide cost tracking as resources are utilized within the cloud-computing environment, and billing or invoicing for consumption of these resources. In one example, these resources can comprise application software licenses. Security provides identity verification for cloud consumers and tasks, as well as protection for data and other resources. User portal 83 provides access to the cloud-computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud-computing environment can be utilized. Examples of workloads and functions that can be provided from this layer include: mapping and navigation 91; software development and lifecycle management 92; virtual classroom education delivery 93; data analytics processing 94; transaction processing 95; and ridesharing management for autonomous vehicles 96.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for ridesharing management for autonomous vehicles, the method comprising:
receiving, by a processor, a rideshare request for an autonomous vehicle;
obtaining, by the processor, preference data associated with an owner of the autonomous vehicle;
obtaining, by the processor, vehicle data associated with the autonomous vehicle;
determining, by the processor, that the autonomous vehicle is available to fulfill the rideshare request using the owner preference data, the vehicle data, and the rideshare request;
generating, by the processor, ridesharing data based at least in part on the determination of the autonomous vehicle availability; and
transmitting, by the processor, the ridesharing data to the autonomous vehicle to facilitate ridesharing based at least in part on the ridesharing data when the autonomous vehicle is available to fulfill the rideshare request.

2. The computer-implemented method of claim 1, wherein the data associated with the requestor is at least one of: calendar data, contact data, or user location data.

3. The computer-implemented method of claim 1 further comprising obtaining requestor or user data, wherein the requestor or user data comprises user preferences, user rideshare history, autonomous vehicle preferences, routing preferences, or payment preferences.

4. The computer-implemented method of claim 1, wherein vehicle data comprises vehicle maintenance information associated with the autonomous vehicle, data obtained from sensors associated with the autonomous vehicle, or rules associated with the autonomous vehicle set by the owner of the autonomous vehicle.

5. The computer-implemented method of claim 1, further comprising:
receiving the rideshare request from a third-party ridesharing service; and
transmitting an indication to the third-party ridesharing server that the autonomous vehicle is available for ridesharing based at least in part on the determination of the autonomous vehicle availability.

6. The computer-implemented method of claim 1, further comprising:
associating the autonomous vehicle to a group of associated autonomous vehicles;
obtaining rules associated with the group of associated autonomous vehicles; and
determining that the autonomous vehicle is available for ridesharing using the rules associated with the group of associated autonomous vehicles, owner preference data for each owner associated with the group, the vehicle data, and the rideshare request.

7. The computer-implemented method of claim 1, further comprising:
determining a ridesharing route using the owner preference data, the vehicle data, and the rideshare request;
determining that the ridesharing route results in the autonomous vehicle being within a predetermine distance of requiring scheduled maintenance; and
transmitting a response to the rideshare requestor that the autonomous vehicle is not available to fulfill the rideshare request.

8. A computer program product comprising a non-transitory storage medium readable by a processing circuit and storing instructions for execution by the processing circuit for performing a method comprising:
receiving a rideshare request for an autonomous vehicle;
obtaining preference data associated with an owner of the autonomous vehicle;
obtaining vehicle data associated with the autonomous vehicle;
determining that the autonomous vehicle is available to fulfill the rideshare request using the owner preference data, the vehicle data, and the rideshare request;
generating ridesharing data based at least in part on the determination of autonomous vehicle availability when the autonomous vehicle is available to fulfill the rideshare request; and
transmitting the ridesharing data to the autonomous vehicle to facilitate ridesharing based at least in part on the ridesharing data.

9. The computer program product of claim 8, wherein the data associated with the requestor is at least one of: calendar data, contact data, or user location data.

10. The computer program product of claim 8 further comprising obtaining requestor or user data, wherein the requestor or user data comprises user preferences, user rideshare history, autonomous vehicle preferences, routing preferences, or payment preferences.

11. The computer program product of claim 8, wherein vehicle data comprises vehicle maintenance information associated with the autonomous vehicle, data obtained from sensors associated with the autonomous vehicle, or rules associated with the autonomous vehicle set by the owner of the autonomous vehicle.

12. The computer program product of claim 8, wherein the method further comprises:
receiving the rideshare request from a third-party ridesharing service; and
transmitting an indication to the third-party ridesharing server that the autonomous vehicle is available for ridesharing based at least in part on the determination of the autonomous vehicle availability.

13. The computer program product of claim 8, wherein the method further comprises:
associating the autonomous vehicle to a group of associated autonomous vehicles;
obtaining rules associated with the group of associated autonomous vehicles; and
determining that the autonomous vehicle is available for ridesharing using the rules associated with the group of associated autonomous vehicles, owner preference data for each owner associated with the group, the vehicle data, and the rideshare request.

14. The computer program product of claim 8, wherein the method further comprises:
determining a ridesharing route using the owner preference data, the vehicle data, and the rideshare request;
determining that the ridesharing route results in the autonomous vehicle being within a predetermine distance of requiring scheduled maintenance; and
transmitting a response to the rideshare requestor that the autonomous vehicle is not available to fulfill the rideshare request.

15. A system, comprising:
a processor in communication with one or more types of memory, the processor configured to:
receive a rideshare request for an autonomous vehicle;
obtain preference data associated with owner of the autonomous vehicle;
obtain vehicle data associated with the autonomous vehicle;
determine that the autonomous vehicle is available to fulfill the rideshare request the owner preference data, the vehicle data, and the rideshare request;
generate ridesharing data based at least in part on the determination of the autonomous vehicle availability; and
transmit the ridesharing data to the autonomous vehicle to facilitate ridesharing based at least in part on the ridesharing data when the autonomous vehicle is available to fulfill the rideshare request.

16. The system of claim 15, wherein the data associated with the requestor is at least one of: calendar data, contact data, or user location data.

17. The system of claim 15, wherein the processor is further configured to obtain requestor or user data, wherein the requestor or user data comprises user preferences, user rideshare history, autonomous vehicle preferences, routing preferences, or payment preferences.

18. The system of claim 15, wherein vehicle data comprises vehicle maintenance information associated with the autonomous vehicle, data obtained from sensors associated with the autonomous vehicle, or rules associated with the autonomous vehicle set by the owner of the autonomous vehicle.

19. The system of claim 15, wherein the processor is further configured to:
receive the rideshare request from a third-party ridesharing service; and
transmit an indication to the third-party ridesharing server that the autonomous vehicle is available for ridesharing based at least in part on the determination of the autonomous vehicle availability.

20. The system of claim 15, wherein the processor is further configured to:
associate the autonomous vehicle to a group of associated autonomous vehicles;
obtain rules associated with the group of associated autonomous vehicles; and
determine that the autonomous vehicle is available for ridesharing using the rules associated with the group of associated autonomous vehicles, owner preference data for each owner associated with the group, the vehicle data, and the rideshare request.
